(19) United States
(12) Patent Application Publication
(10) Pub. No.: US 2022/0017803 A1
(43) Pub. Date: Jan. 20, 2022

(54) VISUALLY DISTINGUISHABLE WORKING FLUIDS

(71) Applicant: 3M INNOVATIVE PROPERTIES COMPANY, St. Paul, MN (US)

(72) Inventors: Bamidele O. Fayemi, Cottage Grove, MN (US); Karl J. Manske, St. Anthony, MN (US)

(21) Appl. No.: 17/296,845

(22) PCT Filed: Nov. 22, 2019
(86) PCT No.: PCT/IB19/60079

§ 371 Date: May 25, 2021

Related U.S. Application Data
(60) Provisional application No. 62/774,526, filed on Dec. 3, 2018.

(51) Int. Cl. C09K 5/10; H01M 10/0525; H01M 10/6567; H01M 10/625; B60L 58/26; F01K 25/00

(52) U.S. Cl. CPC C09K 5/10; H01M 10/0525; H01M 10/6567; H01M 2220/20; B60L 58/26; F01K 25/00; H01M 10/625

(57) ABSTRACT

A working fluid includes one or more halogenated compounds in an amount of at least 80 wt. %, based on the total weight of the working fluid. The working fluid also includes a colorant uniformly disposed throughout the working fluid in an amount such that the colorant is detectable to the unaided human eye. The working fluid is nonflammable.

### FIELD

The present disclosure relates to working fluids that may be readily distinguished from water upon visual inspection.

### BACKGROUND

Various colored working fluids are described in, for example, U.S. Pat. Nos. 7,708,903, 4,758,366, and 7,276,177.

### SUMMARY

In some embodiments, a working fluid is provided. The working fluid includes one or more halogenated compounds in an amount of at least 80 wt. %, based on the total weight of the working fluid. The working fluid also includes a colorant uniformly disposed throughout the working fluid in an amount such that the colorant is detectable to the unaided human eye. The working fluid is nonflammable.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### DETAILED DESCRIPTION

Electrical components in electrified vehicles typically require thermal management. Improved methods of thermal management are sought to simplify or improve the efficiency of heat transfer to/from components needed for performance, reliability, safety, and increased useful life.

Immersion cooling of electronics or electrochemical cells has been identified as a means of improving thermal performance. Desired properties for immersion cooling fluids include high thermal conductivity, low electrically conductivity, and non-flammability (i.e. no flash point) or low flammability). Fluorinated hydrocarbons, such as partially or perfluorinated fluorocarbons, fluoroethers, fluoroketones, and fluoroolefins have these desired properties. However, these fluids are typically clear and colorless. In automotive applications, other fluids used for thermal management, lubrication, or other applications may also be similar in appearance (e.g., water). Consequently, methods to distinguish immersion cooling fluids from other fluids used in electrified vehicles are desirable. Such methods will also facilitate diagnose of fluid leaks during vehicle operation or servicing. Such compositions and should be reliable and not impact the performance (in terms of, for example, thermal conductivity, electrically conductivity, and flammability) of the immersion cooling fluid.

Fluorinated fluids have little to no solubility for common colorants used in automotive applications. Solubilizing agents may be employed to improve colorant solubility. These solubilizing agents are typically hydrocarbon solvents e.g. hexane, octane, decane, and hexadecane, dimethyl ether, mineral oils, xylene and naphthalene. Such solvents, however, are highly flammable, and therefore pose safety risks in electronic or energy storage immersion cooling applications. Moreover, solubilizing agents are also often incompatible with system materials. For example, dioctyl phthalate (DOP), a common plasticizer for rubber seals and flexible hoses found in electrified vehicle systems has good solubility in xylene.

Consequently, colored working fluids that perform equivalently (in terms of, for example, thermal conductivity, electrically conductivity, flammability, and material compatibility) to uncolored working fluids are desirable.

As used herein, “catenated heteroatom” means an atom other than carbon (for example, oxygen, nitrogen, or sulfur) that is bonded to at least two carbon atoms in a carbon chain (linear or branched or within a ring) so as to form a carbon-heteroatom-carbon linkage.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

As used herein, “solubilizing agents” means hydrocarbon solvents such as hexane, octane, decane, and hexadecane, dimethyl ether, mineral oils, xylene, naphthalene, toluene, and the like. Such hydrocarbon solvents comprise compounds that contain carbon and hydrogen and may also contain heteroatoms such as oxygen, nitrogen, or sulfur.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure is directed to working fluids that (i) may be readily identified (e.g., distinguished from water or other uncolored/clear fluid) based on visual inspection; and (ii) exhibit the desirable performance attributes of current uncolored working fluids.

In some embodiments, such working fluids may include one or more halogenated compounds, one or more colorants, and, optionally, one or more solubilizing agents.

In some embodiments, the halogenated compounds may include fluorinated compounds, chlorinated compounds, brominated compounds, or combinations thereof.

In some embodiments, the halogenated compounds may include fluorinated compounds. The fluorinated compounds may include any fluorinated compound exhibiting any one of, any combination of, or all of the following properties: sufficiently low melting point (e.g., <−40 degrees C.) and high boiling point (e.g., >80 degrees C. for single phase heat transfer), high thermal conductivity (e.g., >0.05 W/m-K), high specific heat capacity (e.g., >800 J/kg-K), low viscosity (e.g., <2 cSt at room temperature), low electrically conductivity (e.g., <1e-7 S/cm), and non-flammability (e.g., no closed cup flashpoint) or low flammability (e.g., flash point>100 F). In some embodiments, such fluorinated compounds may include or consist of any one or combination of fluoroethers, fluorocarbons, fluoroketones, fluorosulfones, and fluoroolefins. In some embodiments, the fluorinated compounds may include or consist of partially fluorinated compounds. In various embodiments, the fluorinated compounds may include or consist of perfluorinated compounds. In some embodiments, the working fluids may include both partially fluorinated and perfluorinated compounds.

In some embodiments, the halogenated compounds may be present in the working fluid in an amount of at least 50 wt. %, at least 80 wt. %, at least 90 wt. %, at least 95 wt. %, or at least 99 wt. %, based on the total weight of the working fluid.

In some embodiments, the working fluids of the present disclosure may include one or more colorants (or dyes or pigments). As used herein, the term “colorant” refers to any substance that imparts color and/or other opacity and/or other visual effect to the composition in which it is present. In some embodiments, the colorants may include materials that absorb light in the visible light region of the electromagnetic spectrum. Suitable colorants may include, for example, commercially available dyes for the azo (e.g, Oil Red O) and anthraquinoe (e.g., Solvent Blue 35) family of colorants. In some embodiments, suitable colorants may include organic dyes such as are azo, anthraquinoe, phthalocyanine blue and green, quinacridone, dioxazine, isoindolinone, or vat dyes.

In some embodiments, the colorant may be present in the working fluid at a concentration such that it is detectable to the unaided human eye. For purposes the present application, “detectable to the unaided human eye” means that the unaided human eye (i.e., without the benefit of a magnifying optical device, other than standard corrective lenses), under natural daylight conditions, can distinguish a working fluid composition that includes the colorant from the same composition without the colorant. In some embodiments, the colorants may be present in the working fluid in an amount of at least 10 parts per million by weight, at least 1 parts per million by weight, at least 0.1 parts per million by weight, based on the total weight of the working fluid. In some embodiments, the colorants may be present in the working fluid in an amount of between 10 and 100 parts per million, between 1 and 10 parts per million, or between 0.1 and 1 parts per million, based on the total weight of the working fluid.

In some embodiments, the colorant may be dispersed, dissolved, or otherwise disposed in the working fluid such that the working fluid has a uniform or substantially uniform color throughout its composition at a wide range of operating temperatures (e.g., between −40 and 85 degrees Celsius, between −20 and 60 degrees Celsius, or between 0 and 40 degrees Celsius). In some embodiments, the colorant may be stable (i.e., (i) non-reactive or substantially non-reactive with or not consumed by the working fluid; and (ii) remain uniformly or substantially uniformly dispersed, dissolved, or otherwise disposed, in the working fluid at a wide range of operating temperatures over a period of at least 1 day, at least 1 hour, or at least 15 minutes. For example, in some embodiments, the colorant may remain detectable in the working fluid to the unaided human and stable over a period of at least 1 year, at least 1 month, or at least 24 hours at temperatures of between −40 and 85 degrees Celsius, between −20 and 60 degrees Celsius, or between 0 and 40 degrees Celsius.

As discussed above, solubilizing agents may be undesirable in the working fluids of the present disclosure at least because they contribute to increased flammability and material incompatibility. Surprisingly, it was discovered that some non-fluorinated dyes have sufficient solubility in fluorinated fluids, without the use of solubilizing agents, such that the working fluid has a uniform or substantially uniform color throughout its composition in the temperature range of interest for certain thermal management applications. In this regard, in some embodiments, the working fluids of the present disclosure may be free of solubilizing agents or include solubilizing agents in small amounts (such that the working fluid is/remains nonflammable). As used herein, “nonflammable” refers to a composition or fluid having no flashpoint at 60 degrees Celsius or less as determined in accordance with ASTM D-3278-96 “Standard Test Methods for Flash Point of Liquids by Small Scale Closed-Cup Apparatus”. In this regard, in some embodiments, solubilizing agents may be present in the working fluid in an amount of less than 10 wt. %, less than 5 wt. %, less than 1 wt. %, or less than 0.5 wt. %, based on the total weight of the working fluid. In embodiments in which the working fluids include partially fluorinated compounds, the working fluids of the present disclosure may be free of solubilizing agents or include solubilizing agents in an amount of less than 10 wt. %, less than 5 wt. %, less than 1 wt. %, or less than 0.5 wt. %, based on the total weight of the working fluid. In embodiments in which the working fluids include perfluorinated compounds, the working fluids of the present disclosure may include solubilizing agents in an amount of less than 10 wt. %, less than 5 wt. %, less than 1 wt. %, or less than 0.5 wt. %, based on the total weight of the working fluid.

In some embodiments, the working fluids of the present disclosure, in addition to be readily identified by visual inspection based on color, may have properties that render them suitable as thermal management fluids for direct and indirect contact electronic immersion cooling applications. As used herein, “direct contact electronic immersion” refers to applications in which the working fluid is permitted to come into direct, physical contact with the electronic component to be thermally managed (as opposed to, for example, being in indirect thermal contact via a heat exchanger). In some embodiments, the working fluids may have electrical conductivity that are less than 1e-7, less than 1e-11, or less than 1e-15, as measured in accordance with a method similar to ASTM D257 at room temperature. In some embodiments, the working fluids may have high thermal conductivity (>0.05 W/m-K), high specific heat capacity (>800 J/kg-K) and low viscosity (<2 cSt at room temperature). In some embodiments, the working fluids of the present disclosure may have a boiling point between 10-200° C., or 30-150° C., 70-100° C.; or greater than 70° C., greater than 30° C., or greater than 10° C. In some embodiments, the working fluids of the present disclosure may have a melting point between −100-0° C., or −70-−20° C., −50-−40° C.; or less than 0° C., less than −20° C., or less than −40° C.

In some embodiments, the working fluids of the present disclosure may be relatively chemically unreactive, thermally stable, and non-toxic. The working fluids may have a low environmental impact. In this regard, the working fluids of the present disclosure may have a zero, or near zero, ozone depletion potential (ODP) and a global warming potential (GWP, 100 yr ITH) of less than 500, 300, 200, 100 or less than 10.

Electrochemical cells (e.g., lithium-ion batteries) are in widespread use worldwide in a vast array of electronic and electric devices ranging from hybrid and electric vehicles to power tools, portable computers, and mobile devices.

Thermal management system for packs of electrochemical cells (e.g., lithium-ion battery packs) are often required to maximize the cycle life of the cells. These types of thermal management systems function to control/maintain uniform temperatures of each cell within the pack. High temperatures can increase the capacity fade rate and impedance of the cells while decreasing their lifespan. Ideally, each individual cell within a pack will be at the same ambient temperature.

While generally safe and reliable energy storage devices, electrochemical cells are subject to catastrophic failure known as thermal runaway under certain conditions. Thermal runaway is a series of internal exothermic reactions that are triggered by heat. The creation of excessive heat can be from electrical over-charge, thermal over-heat, or from an internal electrical short. Internal shorts are typically caused by manufacturing defects or impurities, dendritic lithium formation, or mechanical damage.

Direct contact fluid immersion of electrochemical cells, or packs of electrochemical cells, can mitigate catastrophic, thermal runaway events while also providing necessary ongoing thermal management for the efficient normal operation of the packs. Immersion cooling and thermal management of batteries can be achieved using a system designed for single phase or two-phase immersion cooling. In either scenario, the fluids are disposed in thermal communication with the electrochemical cells to maintain, increase, or decrease the temperature of the electrochemical cells (i.e., heat may be transferred to or from the electrochemical cells via the fluid).

In some embodiments, the present disclosure relates to an electrochemical cell pack that contains the working fluids of the present disclosure, according to some embodiments. Generally, the electrochemical cell packs may include a housing that contains a plurality of electrochemical cells. The working fluids of the present disclosure may be disposed within the housing such that the fluid is in thermal communication with one or more (up to all) of the electrochemical cells. Thermal communication may be achieved via direct contact immersion, or indirect thermal contact. In embodiments in which direct contact immersion is employed, the working fluid may surround and directly contact any portion (up to totally surround and directly contact) one or more (up to all) of the electrochemical cells. In some embodiments, the electrochemical cells may be rechargeable batteries (e.g., rechargeable lithium-ion batteries).

In some embodiments (not shown), the working fluid may be circulated (e.g., via a pump) within or to/from the housing. For example, the working fluid may be provided to the housing though pipes or hoses and may flow around or between the electrochemical cells before periodically or continuously being routed to a radiator or heat exchanger. In some embodiments, after flow through the radiator or heat exchanger, the working fluid may be once again routed to the electrochemical cells. Alternatively, the working fluid may not be circulated within or to/from the housing.

Electrochemical cell packs of the present disclosure may be disposed in, and configured to supply power to, any number of devices or machines. For example, such devices or machines may include automobiles, motorcycles, boats, airplanes, power tools, or any other device or machine.

While the present disclosure is primarily directed to use of the working fluids in thermal management of electrochemical cells, it is to be appreciated that the working fluids of the present disclosure may be used in any thermal management application where quick, visual identification of a working fluid may be desirable. Such applications may include semiconductor manufacturing, and electronics cooling (e.g. power electronics, transformers, or computers/servers).

In some embodiments, the present disclosure may be directed to methods for cooling electronic components. Generally, the methods may include at least partially immersing a heat electronic generating component (e.g., electrochemical cell) in the working fluid of the present disclosure. The method may further include transferring heat from the heat generating electronic component using the working fluid.

In some embodiments, the present disclosure is further directed to an apparatus for heat transfer that includes a device and a mechanism for transferring heat to or from the device. The mechanism for transferring heat may include the working fluid of the present disclosure.

The provided apparatus for heat transfer may include a device. The device may be a component, work-piece, device, machine, or assembly to be cooled, heated or maintained at a predetermined temperature or temperature range. Such devices include electronic components, mechanical components, and optical components. In some embodiments, the device can include a chiller, a heater, or a combination thereof.

The provided apparatus may include a mechanism for transferring heat. The mechanism may include the working fluid of the present disclosure. Heat may be transferred by placing the heat transfer mechanism in thermal contact with the device. The heat transfer mechanism, when placed in thermal contact with the device, removes heat from the device or provides heat to the device, or maintains the device at a selected temperature or temperature range. The direction of heat flow (from device or to device) is determined by the relative temperature difference between the device and the heat transfer mechanism.

The heat transfer mechanism may include facilities for managing the heat-transfer fluid, including, but not limited to pumps, valves, fluid containment systems, pressure control systems, condensers, heat exchangers, heat sources, heat sinks, refrigeration systems, active temperature control systems, and passive temperature control systems.

Heat can be transferred by placing the heat transfer mechanism in thermal communication with the device. The heat transfer mechanism, when placed in thermal communication with the device, removes heat from the device or provides heat to the device, or maintains the device at a selected temperature or temperature range. The direction of heat flow (from device or to device) is determined by the relative temperature difference between the device and the heat transfer mechanism. The provided apparatus can also include refrigeration systems, cooling systems, testing equipment and machining equipment.

### Listing of Embodiments

1. A working fluid comprising:

one or more halogenated compounds in an amount of at least 80 wt. %, based on the total weight of the working fluid;

a colorant uniformly disposed throughout the working fluid in an amount such that the colorant is detectable to the unaided human eye;

wherein the working fluid is nonflammable.

2. The working fluid of embodiment 1, wherein the halogenated compounds comprise a fluorinated compound.
3. The working fluid of embodiment 2, wherein the fluorinated compounds comprise a fluoroether, a fluorocarbon, a fluoroketone, a fluorosulfone, or a fluoroolefin.
4. The working fluid of any one of embodiments 2-3, wherein the fluorinated compounds comprise a partially fluorinated compound.
5. The working fluid of any one of embodiments 2-3, wherein the fluorinated compounds consist of partially fluorinated compounds.
6. The working fluid of any one of embodiments 2-3, wherein the fluorinated compounds comprise a mixture of one or more perfluorinated compounds and one or more partially fluorinated compounds.
7. The working fluid of any one of embodiments 2-3, wherein the fluorinated compounds consist of one or more perfluorinated compounds.
8. The working fluid of any one of the previous embodiments, wherein the colorant comprises an organic dye.
9. The working fluid of any one of the previous embodiments, wherein the colorant is present in an amount of between 10 and 100 parts per million, based on the total weight of the working fluid.
10. The working fluid of any one of the previous embodiments, wherein the colorant is at least partially dissolved in the halogenated compound.
11. The working fluid of any one of the previous embodiments, wherein any solubilizing agents, collectively, are present in the working fluid in an amount of less than 10 wt. %, based on the total weight of the working fluid.
12. The working fluid of any one of the previous embodiments, wherein the working fluid has a thermal conductivity of greather than 0.05 W/m-K.
13. The working fluid of any one of the previous embodiments, wherein the working fluid has a specific heat capacity of greater than 800 J/kg-K.
14. The working fluid of any one of the previous embodiments, wherein the working fluid has a viscosity of less than 2 cSt at room temperature.
15. The working fluid of any one of the previous embodiments, wherein the working fluid has a boiling point of between 10 and 200 degrees Celsius.
16. A thermal management system comprising:

a housing having an interior space;

an electrochemical cell disposed within the interior space; and

a working fluid according to any one of embodiments 1-15 disposed within the interior space such that the electrochemical cell is in thermal communication with the working fluid.

17. An electric vehicle comprising the thermal management system of embodiment 16.

### EXAMPLES

Objects and advantages of this disclosure are further illustrated by the following illustrative examples. Unless otherwise noted, all parts, percentages, ratios, etc. in the examples and the rest of the specification are by weight, and all reagents used in the examples were obtained, or are available, from general chemical suppliers such as, for example, Sigma-Aldrich Corp., Saint Louis, Mo., US or may be synthesized by conventional methods.

The following abbreviations are used herein: hr=hours, min=minutes, g=grams, μm=micrometers (10⁻⁶ m), ° C.=degrees Celsius, wt %=percentage by weight, ml-milliliters.

| Material | Description | Source |
|---|---|---|
| NOVEC 7200 | Fluorinated Fluid | 3M Company, Saint Paul, MN, US |
| NOVEC 7300 | Fluorinated Fluid | 3M Company, Saint Paul, MN, US |
| FC-3283 | Perfluorinated Fluid | 3M Company, Saint Paul, MN, US |
| OPTEON SF10 | Fluorinated Fluid | Chemours, Wilmington, DE, US |
| Oil Red O | Azo Dye | Sigma-Aldrich Corp., Saint Louis, |
| | | MO, US |
| Solvent | Anthraquinone Dye | Sigma-Aldrich Corp., Saint Louis, |
| Blue 35 | | MO, US |
| Xylenes | Solubilizing Agent | Sigma-Aldrich Corp., Saint Louis, |
| | | MO, US |
| Toluene | Solubilizing Agent | Sigma-Aldrich Corp., Saint Louis, |
| | | MO, US |

### Examples 1-6: No Added Solubilizing Agent

Working fluid Examples 1-6 were prepared at room temperature as follows. Each fluid sample was saturated by adding small amounts of either Oil Red 0 and Solvent Blue 35 dye to approximately 4 g of each fluorinated fluid until excess dye was visible in the form of solid particles. Samples were agitated by hand for approximately 5 seconds, then kept at room temperature (approximately 25° C.) for approximately 24 hr, after which they were each filtered with WHATMAN #5 (2.5 μm) filter paper.

Samples were then visually observed at room temperature (approximately 25° C.) and at −50° C. for color, and the results are summarized in Table 1. In Tables 1, 3, and 6, a rating of “O” indicates that no color was visible to the unaided eye, “XO” indicates that the example had some visually detectable color, and “X” indicates that the working fluid had an easily detectable color.

TABLE 1
Visual Inspection of Working Fluids at Room
Temperature and −50° C.

| Ex | Fluid | Dye | Amount of Dye | 25° C. | −50° C. |
|---|---|---|---|---|---|
| 1 | NOVEC 7200 | Oil Red O | Saturated | X | X |
| | | | (0.0074 wt %) | | |
| 2 | NOVEC 7300 | Oil Red O | saturated | mild color | mild color |
| 3 | OPTEON SF10 | Oil Red O | saturated | mild color | mild color |
| 4 | NOVEC 7200 | Solvent | Saturated | X | X |
| | | Blue 35 | (0.0056 wt %) | | |
| 5 | NOVEC 7300 | Solvent | saturated | X | X |
| | | Blue 35 | | | |
| 6 | OPTEON SF10 | Solvent | saturated | X | X |
| | | Blue 35 | | | |

### Examples 7-12: Small Amounts of Solubilizing Agent

Examples 7-12 were prepared at room temperature (approximately 25° C.) by first making solutions of approximately Oil Red 0 dye or Solvent Blue 35 dye in xylenes in the amounts shown in Table 2. Each dye/xylenes solution was subsequently introduced into approximately 4 grams of working fluid, until concentrations of the solubilized dyes were in the range of 0.006-0.009 wt % as indicated in Table 3.

TABLE 2
Dye + Solubilizing Agent Solutions
Used to Prepare Examples 7-12

| | Solubilizing | | Amount of |
|---|---|---|---|
| Solution | Agent | Dye | Dye (wt %) |
| A | Xylenes | Oil Red O | 3.37 |
| B | Xylenes | Solvent Blue | 2.59 |
| | | 35 | |

Samples were kept at room temperature (approximately 25° C.) for approximately 24 hr, after which they were each filtered with WHATMAN #5 (2.5 μm) filter paper. Samples were then visually observed at room temperature (approximately 25° C.) and at −50° C. for color using the same scale that was used for Examples 1-6. The results are summarized in Table 3.

TABLE 3
Visual Inspection of Working Fluids at Room
Temperature and −50° C.

| | | | Amount of | | | |
|---|---|---|---|---|---|---|
| | | Dye + | Solvent + Dye | Amount of | | |
| | | Solvent | Solution | Dye | | |
| Ex. | Fluid | Solution | (wt %) | (wt %) | 25° C. | −50° C. |
| 7 | NOVEC | A | 0.22 | 0.0076 | X | X |
| | 7200 | | | | | |
| 8 | NOVEC | A | 0.21 | 0.0070 | XO | XO |
| | 7300 | | | | | |
| 9 | OPTEON | A | 0.31 | 0.0085 | X | X |
| | SF10 | | | | | |
| 10 | NOVEC | B | 0.24 | 0.0064 | X | X |
| | 7200 | | | | | |
| 11 | NOVEC | B | 0.24 | 0.0064 | XO | XO |
| | 7300 | | | | | |
| 12 | OPTEON | B | 0.27 | 0.0071 | X | X |
| | SF10 | | | | | |

### Examples 12-13: Mixtures of Fluorinated Fluids

Examples 13 and 14 comprised mixtures of fluorinated fluids and were prepared as follows. A saturated solution of dye in toluene was prepared by mixing approximately 10 ml of toluene with Solvent blue 35 dye, ensuring that undissolved dye could be observed visually in the solution. The sample of toluene+dye was agitated by hand for approximately 5 seconds and then left undisturbed at room temperature for approximately 30 minutes, after which it was filtered with WHATMAN #5 (2.5 μm) filter paper. In order to determine the concentration of dye in toluene, a known sample weight of the mixture was placed in an aluminum weigh boat and dried for over 24 hours. The residue was weighed and the concentration of the dye in the fluid was then calculated as shown in Table 4.

TABLE 4
Dye/Solvent Solution Used to Prepare Examples 13 and 14

| | unit | amount |
|---|---|---|
| Weigh boat (empty) mass | g | 1.0834 |
| Weigh boat + toluene/dye solution | g | 2.2603 |
| mass | | |
| Weigh boat + dye (after drying) mass | g | 1.1007 |
| Toluene/dye solution mass | g | 1.1769 |
| Dye mass | g | 0.0173 |
| Dye in toluene/dye saturated solution | wt % | 1.47 |

To make Examples 13 and 14, quantities of the dye/toluene solution and NOVEC 7200 (listed in Table 5) were combined with approximately 4 g of FC-3283 in that order in a glass vial. The mixtures were then agitated by hand for approximately 5 seconds. Samples were kept at room temperature for approximately 30 min, after which they were each filtered with WHATMAN #5 (2.5 μm) filter paper. Samples were then visually observed at room temperature (approximately 25° C.) and at −50° C. for color using the same scale that was used for Examples 1-12. The results are summarized in Table 6.

TABLE 5
Compositions of Fluorinated Fluid Mixtures

| | | | Amount | | | Amount of | Amount of |
|---|---|---|---|---|---|---|---|
| | | | of Fluid 2 | Solubilizing | | Solvent + Dye | Dye |
| Ex. | Fluid 1 | Fluid 2 | (wt %) | Agent | Dye | (wt %) | (calculated, wt %) |
| 13 | FC-3283 | NOVEC 7200 | 10.2 | Toluene | Solvent Blue 35 | 1.55 | 0.023 |
| 14 | FC-3283 | NOVEC 7200 | 40.4 | Toluene | Solvent Blue 35 | 0.93 | 0.014 |

TABLE 6
Visual Inspection of Working Fluids at Room
Temperature and −50° C.

| Ex. | 25° C. | −50° C. |
|---|---|---|
| 13 | XO# | O* |
| 14 | X | X |

^{#}Very mild color was observed.
*FC-3283 froze at −50° C., which resulted in phase separation from Novec 7200

### Examples 14-21: Flammability of Mixtures of Fluorinated Fluid and Solubilizing Agent

Mixtures of NOVEC 7200 fluorinated fluid and toluene were prepared in the amounts listed in Table 7 and tested for closed cup flash point according to the procedures outlined in ASTM D-3278-96 e-1 “Standard Test Methods for Flash Point of Liquids by Small Scale Closed-Cup Apparatus.” As shown in Table 7, mixtures containing up to and including 9 wt % toluene were found to be non-flammable (i.e., demonstrated no flash point) according to the ASTM test method.

TABLE 7
Closed-Cup Flash Point of Fluorinated
Fluid and Solubilizing Agent Mixtures

| Ex. | Toluene (wt %) | Flash point (° C.) |
|---|---|---|
| 15 | 1 | None |
| 16 | 2 | None |
| 17 | 3 | None |
| 18 | 4 | None |
| 19 | 5 | None |
| 20 | 6 | None |
| 21 | 7 | None |
| 22 | 8 | None |
| 23 | 9 | None |
| 24 | 10 | −1 |
| 25 | 25 | −2 |
| 26 | 50 | −3 |

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

What is claimed:

1. A working fluid comprising:
one or more halogenated compounds in an amount of at least 80 wt. %, based on the total weight of the working fluid;
a colorant uniformly disposed throughout the working fluid in an amount such that the colorant is detectable to the unaided human eye;
wherein the working fluid is nonflammable.

2. The working fluid of claim 1, wherein the halogenated compounds comprise a fluorinated compound.

3. The working fluid of claim 2, wherein the fluorinated compounds comprise a fluoroether, a fluorocarbon, a fluoroketone, a fluorosulfone, or a fluoroolefin.

4. The working fluid of claim 3, wherein the fluorinated compounds comprise a partially fluorinated compound.

5. The working fluid of claim 3, wherein the fluorinated compounds consist of partially fluorinated compounds.

6. The working fluid of claim 3, wherein the fluorinated compounds comprise a mixture of one or more perfluorinated compounds and one or more partially fluorinated compounds.

7. The working fluid of claim 3, wherein the fluorinated compounds consist of one or more perfluorinated compounds.

8. The working fluid of claim 3, wherein the colorant comprises an organic dye.

9. The working fluid of claim 3, wherein the colorant is present in an amount of between 10 and 100 parts per million, based on the total weight of the working fluid.

10. The working fluid of claim 3, wherein the colorant is at least partially dissolved in the halogenated compound.

11. The working fluid of claim 3, wherein any solubilizing agents, collectively, are present in the working fluid in an amount of less than 10 wt. %, based on the total weight of the working fluid.

12. The working fluid of claim 3, wherein the working fluid has a thermal conductivity of greather than 0.05 W/m-K.

13. The working fluid of claim 3, wherein the working fluid has a specific heat capacity of greater than 800 J/kg-K.

14. The working fluid of claim 3, wherein the working fluid has a viscosity of less than 2 cSt at room temperature.

15. The working fluid of claim 3, wherein the working fluid has a boiling point of between 10 and 200 degrees Celsius.

16. A thermal management system comprising:
a housing having an interior space;
an electrochemical cell disposed within the interior space; and
a working fluid according to claim 3 disposed within the interior space such that the electrochemical cell is in thermal communication with the working fluid.

17. An electric vehicle comprising the thermal management system of claim 16.
